(19) United States
(12) Patent Application Publication
(10) Pub. No.: US 2025/0026181 A1
(43) Pub. Date: Jan. 23, 2025

(54) AIR FILTERING SYSTEM

(71) Applicant: MAHLE INTERNATIONAL GMBH, Stuttgart (DE)

(72) Inventors: Daniel EBERLE, Ludwigsburg (DE); Markus Daniel Johannes STEPPE, Renningen (DE); Sven PETZNER, Welzheim (DE)

(21) Appl. No.: 18/772,510

(22) Filed: Jul. 15, 2024

(30) Foreign Application Priority Data
Jul. 18, 2023 (DE) 102023206794.3

(51) Int. Cl. B60H 3/00; B03C 3/155; B03C 3/41; B60H 3/06

(52) U.S. Cl. CPC B60H 3/0071; B03C 3/155; B03C 3/41; B60H 3/06

(57) ABSTRACT

A filtering system for filtering air is provided, which contains a filter for filtering particles out of the air and an ionizer that contains at least one electrode assembly upstream of the filter. An improved and longer filtering effect is obtained in that at least one of the electrode assemblies generates a negative corona discharge in a first operating mode, and at least one of the electrode assemblies generates a positive corona discharge in a second operating mode. An air conditioner and a vehicle that has such a filtering system is provided.

### CROSS-REFERENCE TO RELATED APPLICATIONS

This application claims priority from German Patent Application No. DE 102023206794.3, filed Jul. 18, 2023, the entirety of which is hereby incorporated by reference herein.

The present invention relates to a system for filtering air, in particular in a vehicle. The invention also relates to an air conditioner and a vehicle that contains such an air filtering system.

There are many reasons to filter air. This is often done with filtering systems. The air flows through the filter, which removes particles such as dust, thus purifying it.

Particularly polluted air contains a large portion of dust or particulates, requiring better filtering. The filter can be larger for this. This requires more installation space.

Many air filters have an ionizer.

This type of air filter for a vehicle is disclosed in EP 3 056 364 A1. The ionizer contains an electrode assembly upstream of the filter that has an electrode and a counter electrode. Voltage is applied to the electrode and counter electrode to obtain a corona discharge with which the particles and molecules in the air are charged and ionized.

The object of the present invention is to create a better, or at least a different, embodiment of such an air filter for an air conditioner and a vehicle, which has a long service life in particular.

This is achieved with the subject matter of the independent claims. Advantageous embodiments are the subject matter of the dependent claims.

The invention is based on the idea of generating both negative and positive corona discharges upstream of a filter in order to ionize the particles in the air. The invention acknowledges that permanent use of a specific polarity of the corona discharge, i.e. a negative or positive corona discharge, results in a quick deterioration of the efficiency of the filter, rapidly decreasing the filtering effect of the system. By way of example, the negative corona discharge near the electrode normally used in the prior art, from which electrodes are accelerated, results in a positive ionization of gas molecules in the air due to the high kinetic energy. As the distance to the electrode increases, electrons are accumulated on gas molecules, while with a negative corona discharge, there is more accumulation of electrons than ionization. Consequently, the filter becomes loaded primarily with negatively charged particles in the air, also referred to as negative air charge carriers. As a result, positively charged particles in the filter, also referred to as positive filter charge carriers, are increasingly neutralized. This results in a reduction in the filtering effect obtained with the filter. Over time, this results in an excess of negatively charged filter particles, such that the filter eventually repels particles in the air. The invention counteracts this by generating both a negative and a positive corona discharge upstream of the filter. The positive corona discharge leads to a reduction in the negatively charged particles in the air, and in particular to a reduction in the accumulation of electrons on the gas molecules. Consequently, both negatively and positively charged air particles come in contact with the filter. As a result, the balance of positively and negatively charged particles is continuously maintained in the filter, or at least over a longer service life. This results in an improved filtering of particles, in particular odors, from the air, at least for a longer period of time. Consequently, an improved and longer filtering effect is obtained.

In accordance with this idea, the air filtering system contains a filter with which particles are filtered out of the air. Air flows through the filter for this. The filtering system also contains an ionizer. The ionizer contains at least one electrode assembly through which the air flows upstream of the filter. The electrode assembly contains at least one electrode and at least one counter electrode, to which a voltage is applied to generate a corona discharge in the air. In a first operating mode, the at least one electrode in the at least one electrode assembly is negatively polarized and the at least one counter electrode is positively polarized. The ionizer is designed for this.

The air first flows through the at least one electrode assembly, and subsequently through the filter, when in operation.

In the first operating mode, a negative corona discharge is generated in the air. This means that the respective electrode assembly generates a negative corona discharge in the air in the first operating mode.

In the second operating mode, a positive corona discharge is generated in the air. This means that the respective electrode assembly generates a positive corona discharge in the air in the second operating mode.

The respective electrode assemblies can generate both negative and positive corona discharges at the same time.

The electrodes are preferably spikes or discharge electrodes in the air flow.

The flow path preferably passes through the respective counter electrodes. Air can therefore flow through the counter electrodes. By way of example, at least one of the counter electrodes can form a channel through which air can flow.

The filter can have any design with which it can filter air by removing particles and preferably odors therefrom.

The filter can be a made with or contain fibers.

The filter is part of a filter element that is located downstream of the at least one electrode assembly in the filtering system.

The filter, or a filter element containing the filter, preferably fills a cross section through which the air can flow. This results in better filtering.

The air filtering system filters air and can be used in numerous applications.

The air filtering system can be used, for example, in an air conditioner, in particular an HVAC system, i.e. a “heating, ventilating, and air conditioning” system.

The air conditioner preferably has at least one heat exchanger through which air flows to transfer heat from the air to the heat exchanger, or vice versa.

The air filtering system is used in particular in a vehicle. It is preferably used to filter air supplied to the interior of the vehicle. This air filtering system can be part of such an air conditioner.

In preferred embodiments, the ionizer is designed such that the polarities of the at least one electrode and counter electrode can be reversed in at least one of the electrode assemblies, such that the electrode assembly can be operated successively in the first operating mode and second operating mode. Consequently, the ionizer only needs one electrode assembly, thus simplifying the air filtering system, and making it less expensive and more compact. With an ionizer that has at least two electrode assemblies, the positions of the negative corona discharge and positive corona discharge can be changed. This results in an improved balance between the charged particles in the filter, and thus an improved, longer-lasting filtering effect.

The “polarity” of an electrode in the present context refers to the polarity obtained with the voltage that is applied thereto.

The ionizer can contain at least two electrode assemblies, which can be operated with opposite polarities. The ionizer is designed for this. The electrode assemblies operated with opposite polarities are also referred to below as the first and second electrode assemblies for purposes of clarity. The ionizer therefore contains at least one first electrode assembly and at least one second electrode assembly. The at least one first electrode assembly can then be operated in the first operating mode, and the at least one second electrode assembly can be operated in the second operating mode, or vice versa.

In particular, the at least one first electrode assembly is operated in the first operating mode, and the at least one second electrode assembly is simultaneously operated in the second operating mode, or vice versa. The ionizer is therefore designed to simultaneously operate the at least one first electrode assembly in the first operating mode, and the at least one second electrode assembly in the second operating mode.

Advantageously, the operation of the at least one first electrode assembly and at least one second electrode assembly alternates between the first and second operating modes. The ionizer is designed for this. This means that for a certain time period, the at least one first electrode assembly is operated in the first mode, and the at least one second electrode assembly is operated in the second mode. This is also referred to below as the first combined operating state. Subsequently, potentially after a short break, the at least one first electrode assembly is operated in the second mode, and the at least one second electrode assembly is operated in the first mode. This is also referred to below as the first combined operating state.

The ionizer is therefore advantageously designed to operate the at least one electrode assembly in the first mode, and the at least one second electrode assembly in the second mode, or vice versa.

In particular, the ionizer is advantageously designed to operate the at least one first electrode assembly in the first mode and the at least one second electrode assembly in the second mode in the first combined operating state. Furthermore, the ionizer is advantageously designed to operate the at least one first electrode assembly in the second mode and the at least one second electrode assembly in the first mode in the second combined operating state.

It is therefore possible to alternate between the first combined operating state and second combined operating state, in particular periodically. The ionizer is designed for this.

To alternate between the combined operating states, the polarities of the at least one first electrode assembly and the at least one second electrode assembly can be reversed, as explained above. The ionizer is designed for this.

If the ionizer has at least one first electrode assembly and at least one second electrode assembly, there is preferably an electrical insulator between them in the flow path. This eliminates, or at least reduces, interactions between the electrode assemblies. This improves the effects of the ionizer, and therefore results in more efficient filtering.

The first operating mode and second operating mode can be implemented successively, alternating in particular, in all of the electrode assemblies. The ionizer is designed such that in a first operating state, all of the electrode assemblies are operated in the first mode, and in a second operating state, all of the electrode assemblies are operated in the second operating mode.

Different electrode assemblies can also be simultaneously operated in the first and second modes. This means that the ionizer contains at least two electrode assemblies, one of which is operated in the first mode, while the other is operated in the second mode, in particular simultaneously.

Embodiments in which electrodes and counter electrodes in the ionizer are transverse to the flow path, in particular adjacent to one another in the middle of the flow path, are preferred. This reduces the flow resistance in the air. Consequently, the air filtering system can be more compact, and is more effective.

If the ionizer has at least two electrode assemblies, air preferably flows through them in parallel. This means that the flow path preferably passes through the electrode assemblies in parallel. The electrode assemblies are preferably transverse to the flow path for this, in particular adjacent to one another in the middle of the flow path. This prevents, or at least reduces, neutralization of the charged particles in the air when they are operated in parallel in the combined operating state. In other words, the service life is increased with an increased filtering effect.

Embodiments in which the at least one electrode assembly lies opposite the filter along the flow path are preferred. This reduces the distance between the at least one electrode assembly and the filter. This improves the filter, such that it more effectively filters out charged particles. This results in a better and longer filtering effect.

It is understood that in addition to the filtering system, the air conditioner and the vehicle containing the filtering system as such also belong to the scope of this invention.

Further features and advantages of the invention can be derived from the dependent claims, drawings, and descriptions in reference to the drawings.

It is understood that the features specified above and described below can be used not only in the given combinations but also in other combinations or in and of themselves without abandoning the framework of the present invention.

Preferred exemplary embodiments of the invention are shown in the drawings, an shall be explained below in greater detail, in which the same reference symbols are used for identical, similar, or functionally identical components.

Therein, schematically:

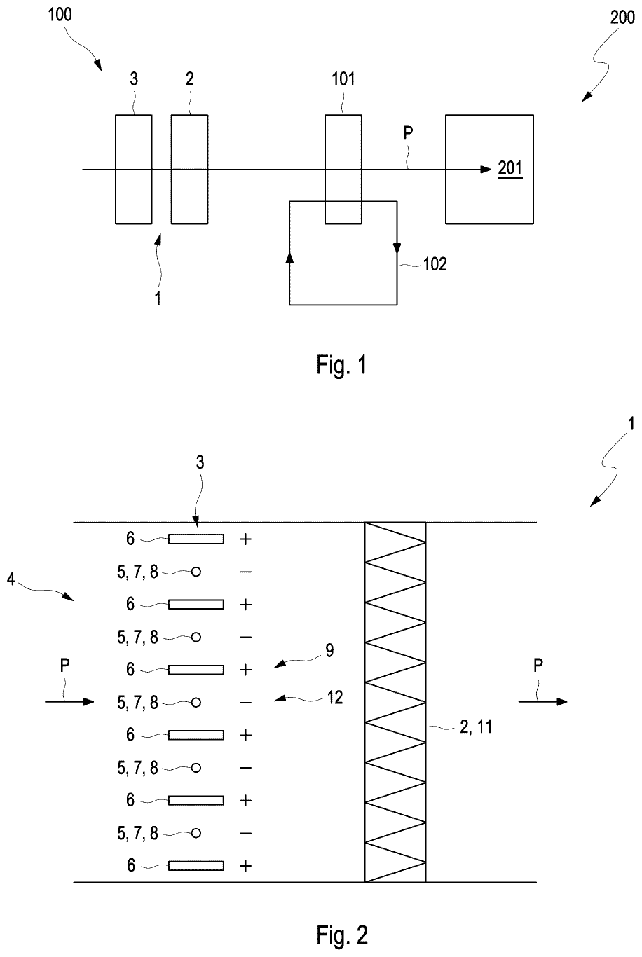

FIG. 1 shows a highly simplified circuit diagram of a filtering system in an air conditioner for a vehicle,

FIG. 2 shows a simplified sectional view of the filtering system in a first operating state,

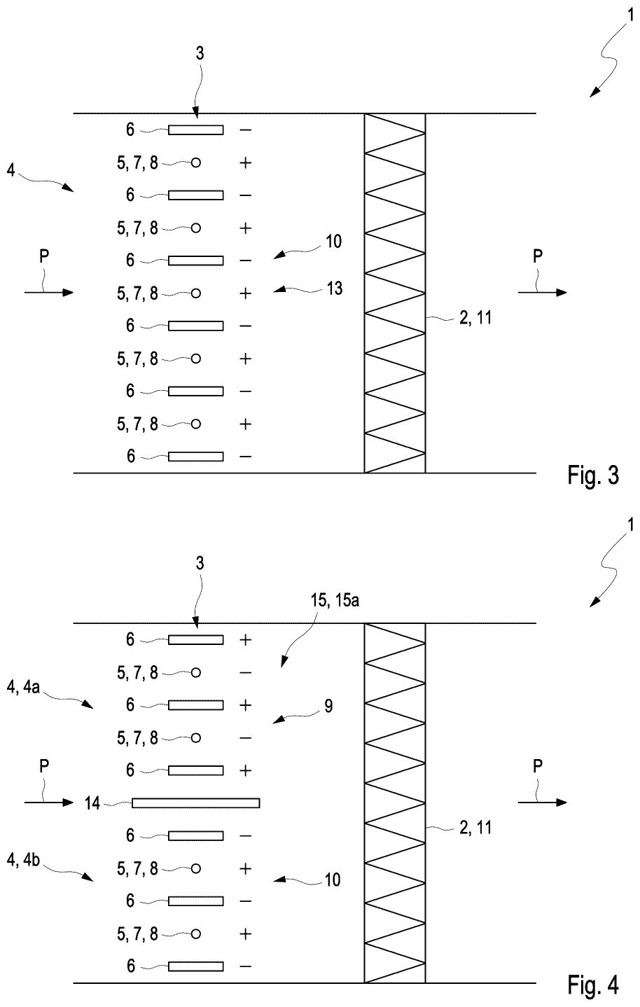

FIG. 3 shows a simplified sectional view of the filtering system in a second operating state,

FIG. 4 shows a simplified sectional view of another exemplary embodiment of the filtering system in a first combined operating state,

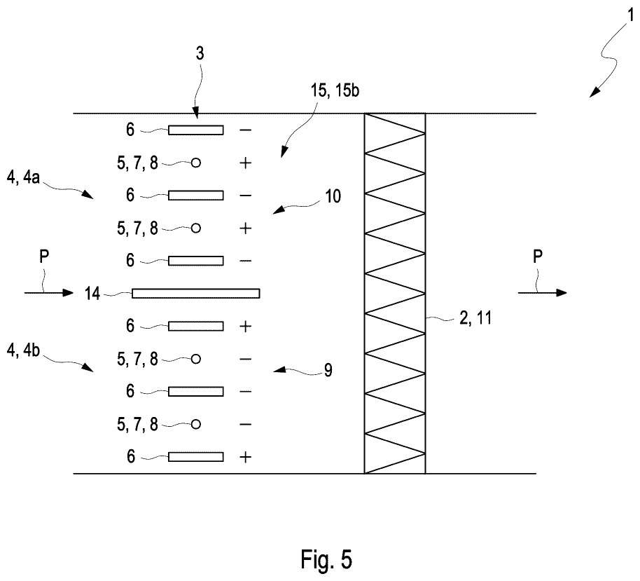

FIG. 5 shows a simplified sectional view of the filtering system shown in FIG. 4, in a second combined operating state.

The filtering system 1 shown in FIGS. 1 to 5 is used to filter air. A flow path P for the air passes through filtering system 1. The filtering system 1 can be used in an air conditioner 100 and/or in a vehicle 200, as can be derived from FIG. 1. The vehicle 200 can contain the air conditioner 100. The air flows into the interior 201 of the vehicle 200 after flowing through the filtering system 1. The interior 201 is therefore downstream of the filtering system 1. The air conditioner 100 contains at least one heat exchanger 101 for exchanging heat with the air. The flow path P therefore passes through the heat exchanger 101. Only one heat exchanger 101 in the air conditioner 100 is visible in FIG. 1, which is downstream of the filtering system 1, merely by way of example. The air conditioner 100 can also contain numerous heat exchangers 101. At least one of the heat exchangers 101 is integrated in a circuit 102 indicated in FIG. 1, through which a fluid, e.g. a refrigerant or coolant, circulates, separately from the air, when the air conditioner 100 is in operation.

The filtering system 1 contains a filter 2 for filtering particles out of the air, as can be seen in particular in FIGS. 2 to 5. The filter 2 can be a fiber filter 11, or it can contain a fiber filter 11. The flow path P for the air flows through the filter 2. The air flows through the filter 2, which then filters particles, e.g. dust or particulates, out of the air. The filter 2 is designed for this. The filter preferably also filters odors out of the air. The filter 2 is preferably electrostatically charged when it is new, thus containing charge carriers (not shown), which are also referred to below as filter charge carriers. The filtering system 2 also contains an ionizer 3 for generating a corona discharge in the air, such that molecules and particles in the air are charged and ionized. Charge carriers are thus generated in the air by the ionizer 3, which are also referred to below as air charge carriers. The ionizer 3 contains at least one assembly 4 comprising electrodes 5, 6. The respective assembly 4 is also referred to below as an electrode assembly 4. The electrode assemblies 4 therefore contains electrodes 5, 6 with different polarities, which are also referred to below as an electrode 5 and counter electrode 6 for purposes of clarity. There is a voltage between the electrodes 5 and counter electrodes 6 in the electrode assemblies 4 for generating a corona discharge. The flow path P passes through the electrode assemblies 4 upstream of the filter 2. The counter electrodes 6 in the exemplary embodiments shown here form channels through which air can flow in the electrode assemblies 4, in which the at least one electrode 5 is located. The electrode 5 is formed by a spike 7 or discharge electrode 8 in the exemplary embodiments shown in the drawings.

As shall be explained below in greater detail in reference to FIGS. 2 to 5, the ionizer 3 is designed such that in a first operating mode 9, the at least one electrode 5 in at least one of the electrode assemblies 4 has a negative polarity, and the at least one counter electrode has a positive polarity. The ionizer 3 is also designed such that in a second operating mode 10, the at least one electrode 5 in at least one electrode assembly 4 has a positive polarity and the at least one counter electrode 6 has a negative polarity. The electrode assemblies 4 can be operated simultaneously in the first operating mode 9 or second operating mode 9. In the first operating mode 9 for the electrode assemblies 4, a negative corona discharge is generated, and a positive corona discharge is generated in the second operating mode 10. This results in a balanced portion of positive and negative filter charge carriers over an extended period of time. The filtering effect is consequently improved and lasts longer.

The at least one electrode assembly 4 in the exemplary embodiments shown in the drawings is opposite the filter 2 in the flow path P. As can be seen in FIGS. 2 to 5, the electrodes 5 and counter electrodes alternate in the ionizer 3, transverse to the flow path P. The ionizer 3 shown in the drawings contains five electrodes 5, purely by way of example.

As can be seen in FIGS. 2 and 3, the ionizer 3 can be designed such that the polarities of the at least one electrode 5 and counter electrode 6 can be reversed in at least one of the electrode assemblies 4. Consequently, the electrode assembly 4 can be operated successively in the first operating mode 9 and second operating mode 10. In the exemplary embodiment shown in FIGS. 2 and 3, the ionizer contains a single electrode assembly 4, in which all of the electrodes 5 have a negative polarity and all of the counter electrodes 6 have a positive polarity in the first operating mode 9 shown in FIG. 2, as indicated by the “+” and “−” signs on the electrodes 5 and counter electrodes 6. By reversing the polarities in the electrode assemblies 4, as can be derived from FIG. 3, all of the electrodes 5 have a positive polarity, and all of the counter electrodes 6 have a negative polarity. In the first operating state 12, shown in FIG. 2, all of the electrode assemblies 4 are therefore operated in the first mode 9. In the second operating state 13, shown in FIG. 3, all of the electrode assemblies 4 are operated in the second mode 10.

As can be derived from FIGS. 4 and 5, the ionizer 3 can also contain at least two electrode assemblies 4, which can be polarized differently at the same time, and shall be referred to as the first electrode assemblies 4, 4a and second electrode assemblies 4, 4b below for purposes of clarity. The ionizer 3 therefore contains at least one first electrode assembly 4, 4a, and at least one second electrode assembly 4, 4b. In the exemplary embodiment shown in FIGS. 4 and 5, the ionizer 3 contains, purely by way of example, one first electrode assembly 4, 4a, and one second electrode assembly 4, 4b. In the exemplary embodiment shown in FIGS. 4 and 5, air flows through the electrode assemblies 4 in parallel. This means that the flow path P runs through the electrode assemblies 4 in parallel.

When the first electrode assembly 4, 4a is in operation, the at least one electrode 5 has a negative polarity, and the at least one counter electrode 6 has a positive polarity, and when the second electrode assembly 4, 4b is in operation, the at least one electrode 5 has a positive polarity, and the at least one counter electrode 6 has a negative polarity, or vice versa. This is indicated in FIGS. 4 and 5, like FIGS. 2 and 3, with the symbols “+” and “−” on the electrodes 5 and counter electrodes 6. The first electrode assembly 4, 4a can therefore be operated in the first mode 9, and the second electrode assembly 4, 4b can be simultaneously operated in the second mode 10, or vice versa. There is an electric insulator 14 between the first electrode assembly 4, 4a, and the second electrode assembly 4, 4b.

It is therefore possible to obtain the combined operating states 15 indicated in FIGS. 4 and 5, in which one of the electrode assemblies 4 is operated in the first mode 9, and the other electrode assembly 4 is simultaneously operated in the second mode 10. FIG. 4 shows a first combined operating state 15, 15a, in which the first electrode assembly 4, 4a is operated in the first mode 9, and the second electrode assembly 4, 4b is operated in the second mode 10. FIG. 5 shows a second combined operating state 15, 15b, in which the first electrode assembly 4, 4a is operated in the second mode 10, and the second electrode assembly 4, 4b is operated in the first mode 9. The ionizer 3 can alternate between the first combined operating state 15, 15a and the second combined operating state 15, 15b, in particular at regular intervals.

The ionizer 3 is designed to implement the operating modes 9, 10, and the operating states 12, 13, 15. By way of example, the ionizer 3 contains a control unit, not shown, for this.

The specification is readily understood with reference to the following Representative Paragraphs:

Representative Paragraph 1. A filtering system (1) for filtering air, in particular for a vehicle (200), containing
a filter (2) for filtering particles out of the air, through which a flow path (P) for the air passes,
an ionizer (3), which contains at least one electrode assembly (4), through which the flow path (P) flows upstream of the filter (2),
wherein the respective electrode assembly (4) contains at least one electrode (5) and one counter electrode (6), which are connected to a voltage in order to generate a corona discharge in the air,
wherein the ionizer (3) is designed to give the at least one electrode (5) a negative polarity and the at least one counter electrode (6) a positive polarity in the first operating mode (9) of at least one of the electrode assemblies (4),
wherein the ionizer (3) is designed to give the at least one electrode (5) a positive polarity and the at least one counter electrode (6) a negative polarity in the second operating mode (9) of at least one of the electrode assemblies (4).

Representative Paragraph 2. The filtering system according to Representative Paragraph 1, characterized in that the ionizer (3) is designed such that the polarities of the at least one electrode (5) and counter electrode (6) can be reversed in at least one of the electrode assemblies (4), such that the electrode assembly (4) can alternate between the first operating mode (9) and second operating mode (10).

Representative Paragraph 3. The filtering system according to Representative Paragraph 1 or 2, characterized in that
the ionizer (3) contains at least one first electrode assembly (4, 4a) and at least one second electrode assembly (4, 4b),
the ionizer (3) is designed such that the at least one first electrode assembly (4, 4a) can be operated in the first mode (9) and the at least one second electrode assembly (4, 4b) can be operated in the second mode (10), or vice versa.

Representative Paragraph 4. The filtering system according to Representative Paragraph 3, characterized in that an electric insulator (14) is placed between the first electrode assembly (4, 4a) and second electrode assembly (4, 4b) in the flow path (P).

Representative Paragraph 5. The filtering system according to any of the Representative Paragraphs 1 to 4, characterized in that the ionizer (3) is designed such that in a first operating state (12), all of the electrode assemblies (4) are operated in the first mode (9), and all of the electrode assemblies (4) are operated in the second mode (10) in a second operating state (13).

Representative Paragraph 6. The filtering system according to Representative Paragraph 4 or 5, characterized in that the ionizer (3) is designed such that in a combined operating state (15), the at least one first electrode assembly (4, 4a) is operated in the first mode (9) and the at least one second electrode assembly (4, 4b) is operated in the second mode (10), or vice versa.

Representative Paragraph 7. The filtering system according to any of the Representative Paragraphs 1 to 6, characterized in that the ionizer (3) contains at least two electrode assemblies (4), through which the flow path (P) passes in parallel.

Representative Paragraph 8. The filtering system according to any of the Representative Paragraphs 1 to 7, characterized in that the at least one electrode assembly (4) and the filter (3) are opposite one another along the flow path (P).

Representative Paragraph 9. An air conditioner (100), in particular for a vehicle (200), through which a flow path (P) for air flows, containing
at least one heat exchanger (101) for exchanging heat with the air, and
a filtering system (1) according to any of the preceding Representative Paragraphs, placed in the flow path (P).

Representative Paragraph 10. A vehicle (200) that has a filtering system (1) according to any of the Representative Paragraphs 1 to 8, in particular with an air conditioner (100) according to Representative Paragraph 9.

1. A filtering system for filtering air, in particular for a vehicle, comprising
a filter configured to filter particles out of the air, through which a flow path for the air passes,
an ionizer, comprising at least one electrode assembly, through which the flow path flows upstream of the filter,
wherein the respective electrode assembly comprises least one electrode and one counter electrode, which are connected to a voltage in order to generate a corona discharge in the air,
wherein the ionizer is configured to provide the at least one electrode a negative polarity and the at least one counter electrode a positive polarity in the first operating mode of at least one of the electrode assemblies,
wherein the ionizer is configured to give the at least one electrode a positive polarity and the at least one counter electrode a negative polarity in the second operating mode of at least one of the electrode assemblies.

2. The filtering system according to claim 1, wherein the ionizer is configured such that the polarities of the at least one electrode and counter electrode can be reversed in at least one of the electrode assemblies, such that the electrode assembly can alternate between the first operating mode and second operating mode.

3. The filtering system according to claim 1, wherein
the ionizer comprises at least one first electrode assembly and at least one second electrode assembly,
the ionizer is configured such that the at least one first electrode assembly can be operated in the first mode and the at least one second electrode assembly can be operated in the second mode, or vice versa.

4. The filtering system according to claim 3, wherein an electric insulator is placed between the first electrode assembly and second electrode assembly in the flow path.

5. The filtering system according to claim 1, wherein the ionizer is configured such that in a first operating state, all of the electrode assemblies are operated in the first mode, and all of the electrode assemblies are operated in the second mode in a second operating state.

6. The filtering system according to claim 4, wherein the ionizer is configured such that in a combined operating state, the at least one first electrode assembly is operated in the first mode and the at least one second electrode assembly is operated in the second mode, or vice versa.

7. The filtering system according to claim 1, wherein the ionizer comprises at least two electrode assemblies, through which the flow path passes in parallel.

8. The filtering system according to claim 1, wherein the at least one electrode assembly and the filter are opposite one another along the flow path.

9. An air conditioner, in particular for a vehicle, through which a flow path for air flows, comprising
at least one heat exchanger for exchanging heat with the air, and
a filtering system according to claim 1, placed in the flow path.

10. A vehicle that has a filtering system according to claim 1, and further comprising, wherein the filtering system in placed in the flow path through which air flows through the vehicle, the vehicle further comprising an air conditioner provided within the air conditioner, and the air conditioner further comprises at least one heat exchanger configured to exchange heat with the air.
